(19) United States
(12) Patent Application Publication
(10) Pub. No.: US 2025/0187191 A1
(43) Pub. Date: Jun. 12, 2025

(54) AVATARS OF MACHINES IN BOUNDARY VALUE PROBLEMS

(71) Applicant: INTERNATIONAL BUSINESS MACHINES CORPORATION, ARMONK, NY (US)

(72) Inventors: Vivek Warrier, Bengaluru (IN); Mukundan Sundararajan, Bangalore (IN); Anita Duggal, Delhi (IN); Sudarshan ., Ghaziabad (IN)

(21) Appl. No.: 18/536,341

(22) Filed: Dec. 12, 2023

(51) Int. Cl. B25J 9/16; G06T 13/40; G06T 19/00

(52) U.S. Cl. CPC B25J 9/1671; B25J 9/1653; B25J 9/1674; G06T 13/40; G06T 19/006

(57) ABSTRACT

According to one embodiment, a method, computer system, and computer program product for industrial robot error correction is provided. The present invention may include monitoring a production line for error conditions; responsive to identifying an error condition in an industrial robot comprising the production line, invoking an AI avatar for the industrial robot; gathering, by the AI avatar, data pertaining to the error condition; analyzing, by the AI avatar, the gathered data to produce a plurality of collated data and/or proposed corrections; presenting, by the AI avatar, the collated data and/or the proposed corrections to a subject matter expert; and modifying algorithms of the industrial robot based on the proposed corrections.

### BACKGROUND

The present invention relates, generally, to the field of computing, and more particularly to the fields of mixed reality and industrial automation.

Mixed reality is a field concerned with merging real and virtual worlds such that physical and digital objects co-exist and interact in real time. Mixed reality does not exclusively take place in either the physical or virtual worlds but is a hybrid of reality and virtual reality; as such, mixed reality describes everything in the reality-virtuality continuum except for the two extremes, namely purely physical environments, and purely virtual environments. Accordingly, mixed reality includes augmented virtuality (AV), augmented reality (AR) and virtual reality (VR). Mixed reality has found practical applications in remote working, social interaction, training programs, and in various industrial contexts.

Industrial automation is a field of science and engineering dedicated to the design, construction, operation, and use of robots in industrial contexts. An industrial robot is a programmable machine that is capable of carrying out a complex series of actions automatically. Today, industrial robots are used in almost all industries, from automotive to plastics and medical technology. Industrial robots excel at many things, such as performing repetitive or precise tasks, or working in environments that are unsafe or uncomfortable for humans.

### SUMMARY

According to one embodiment, a method, computer system, and computer program product for industrial robot error correction is provided. The present invention may include monitoring a production line for error conditions; responsive to identifying an error condition in an industrial robot comprising the production line, invoking an AI avatar for the industrial robot; gathering, by the AI avatar, data pertaining to the error condition; analyzing, by the AI avatar, the gathered data to produce a plurality of collated data and/or proposed corrections; presenting, by the AI avatar, the collated data and/or the proposed corrections to a subject matter expert; and modifying algorithms of the industrial robot based on the proposed corrections.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a machine error correction process according to at least one embodiment;

FIG. 3 is a diagram illustrating an exemplary implementation of a machine error correction process according to at least one embodiment; and

FIG. 4 is a diagram illustrating an exemplary implementation of a machine error correction process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to industrial automation. The following described exemplary embodiments provide a system, method, and program product to, among other things, identify an error condition in an industrial robot on a production line, and assign an AI avatar to the industrial robot to investigate the cause of the error condition, identify a correction, and transmit the correction to the industrial robot.

As previously described, mixed reality is a field concerned with merging real and virtual worlds such that physical and digital objects co-exist and interact in real time and encompasses both augmented reality (AR) and virtual reality (VR). As previously described, AR is a modern computing technology that uses software to generate images, sounds, haptic feedback, and other sensations which are integrated into a real-world environment to create a hybrid augmented reality environment, comprising both virtual and real-world elements. VR is a modern computing technology that creates a virtual environment that fully replaces the physical environment, such that a user experiencing a virtual reality environment cannot see objects or elements of the physical world; however, the virtual reality environment is anchored to real-world locations, such that the movement of players, virtual objects, virtual environmental effects and elements all occur relative to corresponding locations in the physical environment. AR is distinct from VR in that an AR environment augments the physical environment by overlaying virtual elements onto the physical environment, whereas a VR environment fully replaces the physical environment with a virtual environment to completely immerse the user in a computer-generated world. In other words, a user within a VR environment cannot see any real-world objects or environments, while a user within an AR environment can see both the physical environment and virtual elements.

One area in which mixed reality stands to yield a significant benefit is that of industrial automation. Industrial automation is a field of science and engineering dedicated to the design, construction, operation, and use of robots in industrial contexts. An industrial robot is a programmable machine that is capable of carrying out a complex series of actions automatically. Today, industrial robots are used in almost all industries, from automotive to plastics and medical technology. Industrial robots excel at many things, such as performing repetitive or precise tasks, or working in environments that are unsafe or uncomfortable for humans. But there are considerable disadvantages associated with industrial robots as well: industrial robots are very expensive, and the physical machinery comprising the industrial robot costs a significant amount of money to maintain and repair. The software animating the industrial robot must likewise be maintained; programs need to be continually supported to fix bugs or address newly discovered vulnerabilities, as well as updated to adapt to changing requirements or conditions, and of course modified to incorporate new features or improvements. In case of breakdown, the cost of repair may be very high. The procedures to restore lost code or data may be time-consuming and costly.

Furthermore, although robots in general can perform better than humans in some contexts, industrial robots are typically animated by software using rules-based programming paradigms that defines the robot's behavior as a curated list of rules, where the rules prescribe particular behaviors, actions, or combinations of actions in response to particular inputs. While such limited logic makes robots efficient, predictable, simple, and reliable, and therefore well suited to industrial contexts, they also render robots largely incapable of adjusting to changes in their environment, in their own hardware and software, in the parameters of their tasks, et cetera. In other words, as robots are designed to perform standard steps based on the standard input parameters provided by the client, operator, programmer, customer, et cetera, they lack the ability to rework the steps to be performed, given a change in the input parameter or specifications.

For example, one of the challenges in using robots in industrial settings is that small changes often occur: specifications of components being manufactured often change, for example based on new variants proposed or sold or if the planning system is using an alternate stock keeping unit with special instructions; when the operational parameters slightly change in the environment; replacement parts for a robot have slightly different dimensions, et cetera. As robots cannot reliably adapt to such minor changes unless specifically programmed to do so, such changes frequently cause robot algorithms to not work as designed, leading to non-regular failure events and a break in the production. For example, an industrial robot may fail to pick up an object due to a positional calculation issue caused by the object not being at the position as estimated from a camera image. In another example an industrial robot may miss a placement due to a positional error or a sensor error, for instance on a bottling line, resulting in occasional bottle capping issues. In another example, a picking robot may be unable to grasp an item because the inputs from the visual recognition showed objects at incorrect positions, or a position robot may be unable to place material in a stable position for the same reason. When such problems occur, they can occasionally cause expensive mishaps, and affected robots may need to be pulled off the line or replaced until the issue is resolved. In another example, the industrial robots working an automotive production line may be tasked with integrating a number of different automotive components together step by step to build a car; however, if there is any non-negligible change in the size or dimensions of a components, the robot interacting with the unexpected component would not be able to proceed further, and may flag an error condition, addressing the issue by removing the offending component, shutting down the line, and/or contacting a human supervisor. Such simple approaches to error resolution are inflexible, and result in wasted resources as well as wasted time, without doing anything to prevent the error from reoccurring. As such, there is a need to quickly provide a correction in response to changes in a robot's operational parameters.

Unfortunately, fixing such errors can be technical, time-consuming, and expensive work; finding faster solutions requires data collection and analysis that should be presented to a subject matter expert. In the context of lights-off manufacturing, where a production line is fully automated, the risk of errors resulting from small changes is compounded by the lack of human line workers, and there is accordingly a need for a supervisory mechanism that can investigate error events, collect and process the necessary data, analyze the data and discuss with subject matter experts outside of the lights-off production line to determine what corrections are needed and to implement them.

Furthermore, for a human user, the very process of conceptually locating and identifying the machine currently suffering an error, as well as interacting with the data pertaining to the error, the code that must be modified or repaired to correct the error, et cetera, may itself be complex and unintuitive, much less fixing it. Manufacturing spaces styled according to the Industry 4.0 (lights off) and Industry 5.0 (product unit-wise tailoring) formats do not have large spaces between equipment. Hence, virtual avatars may be needed to help address problems by virtually observing the production line operation, and by bringing in and positioning additional sensors to collect more content/information to compensate for the difficulty a human investigator may face in accessing a machine in the manufacturing space experiencing an error condition. The avatar can investigate the problem and then interface with human operators in a remote location to communicate the measurements and the surrounding environments contributing to the problem. As observed by the avatar and its ability to participate in a conversation, if there are gaps or additional data points needed, the avatar can very quickly obtain, assemble and analyze the information to use in natural language discussions, not merely relay or replay the data observations in the situation, and thereby leverage the convenience, and natural interaction, and abstraction away from the physical site of the problem that may be inaccessible or difficult to access for humans, which is made possible by the mixed-reality format.

As such, it may be advantageous to, among other things, implement a system that monitors a production line for errors, and once an error is detected, invokes an AI avatar to address the error; the AI avatar may collect available error data, collect additional data from sensors deployed on and around the production line, and analyze the data to synthesize a correction to the error; the AI avatar may verify that the correction is sufficient to correct the error by simulating the correction in a digital model, and then may present the correction to a subject matter expert; once verified by the subject matter expert, the system may push the correction out to the affected machine. It may further be advantageous to create a virtual avatar of the error-stricken machine within a mixed-reality platform that is capable of natural-language interaction with a human user, and which communicates the error, possible fixes, relevant data, et cetera to human subject matter experts, fields queries from the human user regarding the error, and receives authorization and/or commands from the user.

Therefore, the present embodiment has the capacity to improve the technical field of industrial automation by providing a method to dynamically respond to errors as they occur, rapidly synthesize a correction, obtain approval from a subject matter expert, and fix the error on a rapid timescale, resulting in fewer interruptions in production, less waste, and greater efficiency. Additionally, the system improves the technical field of industrial automation by providing a software agent that is capable of investigating anomalous robot behavior in fully automated environments which might be unsafe, uncomfortable, or even inaccessible to humans. Furthermore, the present embodiment has the capacity to improve the technical field of mixed reality by linking industrial robots to virtual avatars in a mixed-reality environment, enabling users to receive the error, analysis, and suggested corrections in the simple, intuitive fashion that only mixed reality can provide.

According to at least one embodiment, the invention is a system that continually monitors a production line comprising one or more robots; responsive to detecting an error condition in the one or more robots, the system invokes an AI avatar and assigns it to the robot experiencing an error condition. The AI avatar identifies a specific process that caused the error, performs analytics on a plurality of available data including production data, sensor data, robot diagnostics, and historical data to identify a correction. The AI avatar verifies the correction by running it through a model, and if the correction solves the error, the AI avatar pushes the correction to the robot experiencing the error condition.

In embodiments, the invention is an AI-based avatar assigned to an industrial robot experiencing an error condition, which analyzes the input parameters, understands the change in parameters or specifications and accordingly reworks the existing automation within boundaries and provides instructions to the malfunctioning robot to execute a task in an alternative way. Alternatively, if the change is complex, the AI avatar may provide the automation designer or developer the information regarding the changes and recommend or receive steps to redesign the solution.

References in the specification to “one embodiment”, “other embodiment”, “another embodiment”, “an embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to identify an error condition in an industrial robot on a production line, and assign an AI avatar to the industrial robot to investigate the cause of the error condition, identify a correction, and transmit the correction to the industrial robot.

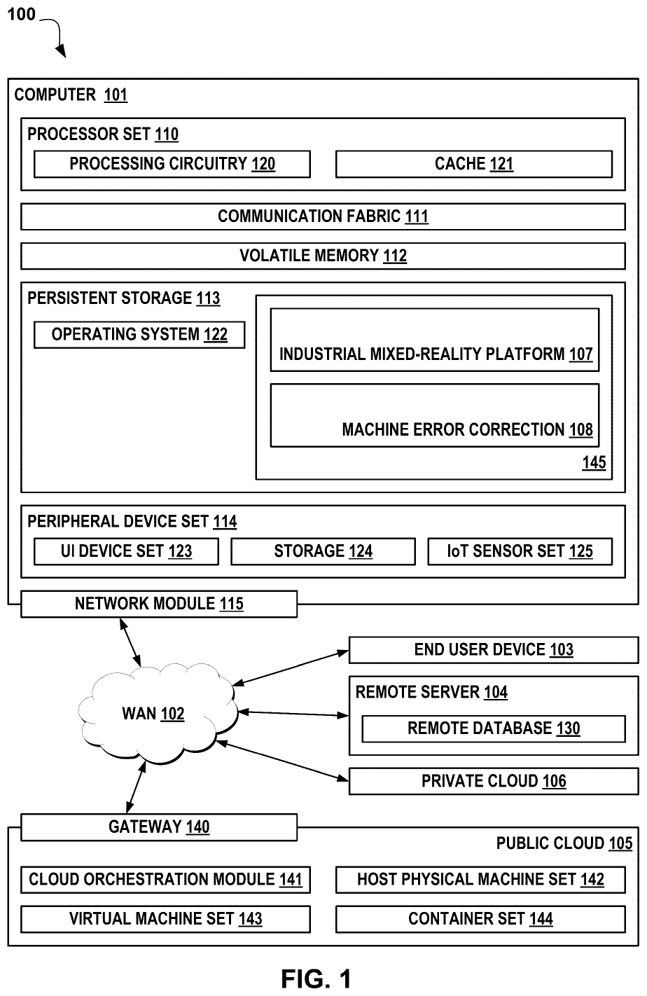

Referring now to FIG. 1, computing environment 100 contains an example of an environment for the execution of at least some of the computer code involved in performing the inventive methods, such as code block 145, which may comprise industrial mixed-reality platform 107 and machine error correction program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the industrial mixed-reality platform 107 may be a program capable of creating and maintaining a mixed-reality environment capable of simultaneously hosting multiple individual human users, wherein the mixed-reality environment comprises a number of virtual elements that participating human users may see and/or interact with through a mixed-reality device. The virtual elements may include representations of industrial robots and/or other industrial machines, such as AI avatars; the virtual elements may further include virtual fences indicating the boundaries of operation and/or movement paths associated with industrial robots and/or machines, text such as instructions, warnings, data, graphical elements highlighting or indicating elements of importance, et cetera. The virtual elements may be bound to constant coordinates within the mixed-reality environment, such that their location, position, orientation, et cetera is consistent among all participating users.

In embodiments, the industrial mixed-reality platform 107 may host an augmented-reality environment, where virtual elements are overlaid onto the real-world environment, and where participating human users may see and interact with the virtual elements; here, human users and virtual elements may be located at their physical coordinates within the real-world environment, such that a user must physically travel to a geographic proximity of another user or virtual element to interact with such user or virtual element.

In embodiments, the industrial mixed-reality platform 107 may host a virtual-reality environment, where all participating human users are represented by virtual avatars within a fully virtual environment and may be able to see and interact with virtual elements comprising the virtual reality environment and the avatars of other participating users. Here, the avatars of participating human users and the virtual elements are bound to locations in the virtual environment, such that participating users may see and interact with each other and virtual elements within the virtual environment even where the users themselves may be located too far apart in the real-world environment to see or interact with each other.

In embodiments of the invention, the industrial mixed-reality platform 107 may simultaneously host multiple mixed-reality environments, which may comprise augmented reality environments, virtual reality environments, or any combination of both augmented reality environments and virtual reality environments, for instance encompassing different locations, or different regions of a single location. For example, an industrial mixed-reality platform 107 may host an augmented-reality environment comprising a real-world production line, and a virtual-reality environment comprising a virtual meeting space accessible by human participants located far from the real-world production line, with one or more AI avatars representing a given industrial robot in one or both mixed-reality environments.

In embodiments of the invention, the industrial mixed-reality platform 107 may be stored and/or run within or by any number or combination of devices including computer 101, end user device 103, remote server 104, private cloud 106, and/or public cloud 105, peripheral device set 114, and/or on any other device connected to WAN 102. Furthermore, industrial mixed-reality platform 107 may be distributed in its operation over any number or combination of the aforementioned devices. The industrial mixed-reality platform 107 may be a subroutine, functionality, module, component, et cetera of machine error correction program 108 and/or may otherwise be integrated into machine error correction program 108. The industrial mixed-reality platform 107 may be a standalone software program that is called, controlled, interacted with or otherwise in communication with and responsive to instructions from machine error correction program 108.

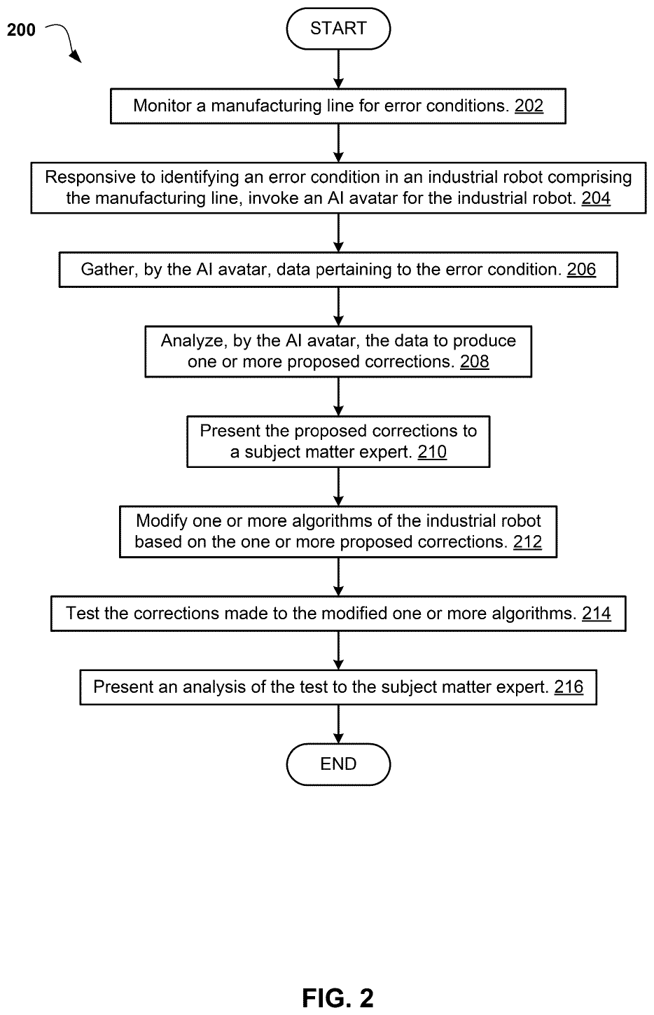

According to the present embodiment, the machine error correction program 108 may be a program capable of identify an error condition in an industrial robot on a production line, and assign an AI avatar to the industrial robot to investigate the cause of the error condition, identify a correction, and transmit the correction to the industrial robot. The machine error correction program 108 may, when executed, cause the computing environment 100 to carry out a machine error correction process 200. The machine error correction process 200 may be explained in further detail below with respect to FIG. 2. In embodiments of the invention, the machine error correction program 108 may be stored and/or run within or by any number or combination of devices including computer 101, end user device 103, remote server 104, private cloud 106, and/or public cloud 105, peripheral device set 114, and/or on any other device connected to WAN 102. Furthermore, machine error correction program 108 may be distributed in its operation over any number or combination of the aforementioned devices.

Referring now to FIG. 2, an operational flowchart illustrating a machine error correction process 200 is depicted according to at least one embodiment. At 202, the machine error correction program 108 may monitor a production line for error conditions. The production line may be a series of workstations along which a physical article, such as a chemical, material or component, is transported; at each workstation, a machine, industrial robot, and/or human worker executes one or more operations on the physical article, which is moved sequentially from workstation to workstation such that a uniform series of operations is executed on each physical article in a specific order. The operations may, for instance, include refining a raw material into an intermediate input or consumable good, executing sequential chemical processes to create a chemical or food item, assembling a machine or object from multiple components, et cetera. As an example, a production line may receive as an input a car chassis, move the car chassis through a series of operations to add various components, and may output a completed car. The production line need not encompass the entire refining or manufacturing process of any given physical article but may encompass any sub-process comprising the manufacturing process that includes two or more separate operations. The production line comprises one or more industrial robots.

An industrial robot may be a programmable machine that is capable of carrying out a complex series of actions automatically, for example to execute an operation on a production line. Industrial robots may be capable of movement on three or more axes, and may comprise gantries, manipulators, prismatic joints, rotary joints, tool mountings, various sensors, et cetera. The operation of an industrial robot may be described by the industrial robot's physical construction; the reach and degrees of freedom of motion of moving parts such as a robotic arm, the movement and motion performed by moving parts of the industrial robot in the process of carrying out a given operation, the size, shape, number, orientation, and other physical traits of physical articles that the industrial robot is designed to accommodate in carrying out an operation on the physical article, the limits of what the industrial robot can sense or detect, et cetera. These characteristics, delineated by the industrial robot's physical construction, may be characterized as “boundaries,” which may represent the limits of what the industrial robot is physically capable of doing. In the space of operation, the extreme points or surfaces define the boundaries of reach, operation, and sensing. In practical terms, the error conditions often occur on or just beyond the boundaries or due to limitations of sensors and their measurements, especially in blind spots.

Error conditions may be anomalous conditions that occur during the execution of an operation that prevents the operation from being successfully carried out. For example, an industrial robot may fail to pick up a physical article due to a positional calculation issue caused by the physical article not being at the position estimated from a camera image. In another example an industrial robot may miss a placement due to a positional error or a sensor error, for instance on a bottling line, resulting in occasional bottle capping issues. The machine error correction program 108 may continuously monitor the software states associated with industrial robots comprising the production line, the sensor data recorded by the industrial robots, and/or sensor data from sensors disposed within the production line while the production line is powered and active; if a software state indicates that the industrial robot has encountered an anomaly, for example where the industrial robot is unable to complete the operation, no longer senses the physical article, et cetera, the machine error correction program 108 may identify the presence of an error state. The machine error correction program 108 may likewise detect an error condition if sensor data from the industrial robot or from external sensors exceeds or falls below a threshold range of values, where the threshold range represents the minimum and maximum values expected from that sensor, beyond which sensor data may indicate an anomaly. The machine error correction program 108 may identify an error condition where external cameras or other sensors show anomalies, such as bad placement of a physical article on the conveyor belt, failure to grasp or hold onto a physical article, physical articles that differ in shape or appearance from what is expected by a threshold value, et cetera.

In embodiments, machine error correction program 108 may additionally or alternatively identify error conditions for an industrial robot when a boundary of that industrial robot is exceeded. For instance, the machine error correction program 108 may identify the error conditions as follows: input materials are rejected for the activities to be performed by the industrial robot. These input materials may have positional coordinates on or across the boundary of the industrial robot or occur in a sensor's blind spot, resulting in the rejection. Other examples of such error conditions may include, for example, situations where a mechanical feeder occasionally misaligns a physical article being input to an industrial robot performing a grinding task, and as a result the industrial robot is not able to detect the edge of the physical article correctly as some part of the edge is outside of the boundary of the camera's vision, causing the physical article to be rejected on quality grounds; another example is where a feed mechanism occasionally provides as input to an industrial robot two physical articles that are vertically stacked in perfect alignment, such that the robot sees the two physical articles as a single physical article and calculates an incorrect depth from the image that does not match the infrared position sensors level check, even though the industrial robot is otherwise capable of identifying varying orientations in detecting the number of layers, resulting in the operation being abandoned for the stack of input articles. The machine error correction program 108 may identify which boundary of the industrial robot was breached, and based on what boundary was breached, the machine error correction program 108 may identify the specific process or algorithm that caused the error and determine the sensing corrections needed, where sensing corrections may here refer to adjustments to be made to the sensors to correct a blind spot or extend the boundary of sensing and measurement so that the input material or raw material can be used by the industrial robot in the step, instead of incorrectly rejecting it.

At 204, the machine error correction program 108 may, responsive to detecting an error condition in an industrial robot comprising the production line, invoke an AI avatar for the industrial robot. The machine error correction program 108 may provide the AI Avatar with the sensor inputs of the industrial robot and the operational data, including the rejection conditions of the current instruction set, and applies a set of conditions such as “can additional measurements be immediately done; if yes, trigger the measurement/instructs the industrial robot to measure again the sensor values” or “has the input raw material moved past the boundary where the issue should be caught; if yes, adds to its temporal error tracking and instructs the industrial robot to continue with the operations.” The AI avatar may be a software agent or subroutine of machine error correction program 108. The AI avatar may be assigned to a single industrial robot and may be associated with a corpus of data pertaining to that industrial robot, or that model of industrial robot. The corpus of data may comprise physical specifications of the industrial robot, past error conditions affecting that industrial robot and any corrections/modifications applied to the industrial robot, past sensor data gathered by or on the industrial robot, et cetera. The AI avatar may be designed to execute a series of instructions to correct an error condition in its associated industrial robot. The machine error correction program 108 may invoke the AI avatar by sending a command to activate the AI avatar associated with the industrial robot in response to detecting an error condition in the industrial robot.

The AI avatar may comprise an interactable digital representation of the industrial robot with which it is associated, which may be integrated into a mixed-reality platform. The AI avatar may be associated with a digital avatar representing the industrial robot in a mixed-reality environment, which may be designed to appear visually similar to the industrial robot, or may be abstract, such as a shape, or anything in between, such as a robot head. Each industrial robot or class of industrial robots on the production line may be represented by visually identical avatars, geometrically identical avatars with visual distinctions such as colors or symbols, or geometrically and visually unique avatars. The digital avatar of the AI avatar may be animated and may move around the mixed-reality environment. The digital avatar may be capable of interacting with users within the mixed reality environment through natural language text, speech, animated behaviors, gestures, symbols, or any number or combination of such. In embodiments, machine error correction program 108 may invoke the AI avatar by instantiating the digital avatar on the industrial mixed-reality platform 107, within one or more mixed-reality environments, such that the digital avatar of the AI avatar becomes visible and interactable to users within the mixed-reality environment. In embodiments, for example in Industry 4.0 manufacturing formats, the industrial robots may be organized into a hierarchy, represented by avatars to support, or supplement the capabilities of physical robots, such hierarchy ensuring avatars do not transgress on each other's domains in terms of data collection, information processing and analysis capabilities.

At 206, the machine error correction program 108 may gather, by the AI avatar, data pertaining to the error condition. The AI avatar may access the corpus of data pertaining to the industrial robot and may access real-time sensor feeds, and may access locally stored historical data, multiple levels of production control, instructions for analysis on similar error conditions, et cetera. The AI avatar may interface with external services, databases, AI avatars at different locations and/or within other systems, et cetera, and retrieve data regarding the industrial robot or the same class of industrial robots and/or similar classes, types, et cetera of error conditions, instructions for analysis on the error condition or similar error conditions, historical information, et cetera. In embodiments, the AI avatar may operate a mobile sensor array that is capable of moving around the production line and recording sensor data of the industrial robot.

At 208, the machine error correction program 108 may analyze, by the AI avatar, the data to produce one or more proposed corrections. The machine error correction program 108 may run analytics on the production data and correlate with higher levels of production control data up to the order level to identify the cause and possible corrections to the error condition. The machine error correction program 108 may perform an analysis by identifying a type or class of error condition, for example by analyzing real-time, recent and historical sensor data and comparing the data against historical patterns associated with particular error conditions to find a match, and identifying corrections made in solving the error condition associated with the matched pattern. The machine error correction program 108 may analyze the software state of the industrial robot and any errors or flags it has thrown, and identify corrections applied in response to historical instances of the industrial robot or similar industrial robots throwing the same errors or flags. The machine error correction program 108 may analyze sensor data and/or software states of the industrial robot to pinpoint the specific joint or axis, tooling, location within the workspace, et cetera where the error occurred, and thereby identify specific components of the industrial robot to perform modifications to in executing a correction, and identify the necessary values for a correction based on the sensor data. The machine error correction program 108 may store any identified corrections as proposed corrections in a database. For example, when machine error correction program 108 identifies that crown caps on a bottling line are not correctly cut and are discarded while sealing soft drink bottles by identifying that the bottling robot is throwing an error that occurs when caps are incorrectly cut, and which triggers a process whereby the bottling robot discards the incorrectly cut bottle caps. The machine error correction program 108 may analyze available historical data pertaining to the same class of bottling robots to identify that the same error code has been thrown before, and in those cases the afflicted industrial robots were modified to improve alignment to allow correct sealing, rather than discarding the crown caps. The machine error correction program 108 may save the modification to improve alignment as a proposed correction in the database. In the process of performing the analysis, the machine error correction program 108 may collate and organize the data used for the analysis, and store the collated data, which may be the data sensed by sensors invoked by the AI avatar and correlating data from other industrial robots on the manufacturing line.

In embodiments, machine error correction program 108 may identify a pattern in error states that recurs or is likely to recur under predictable conditions. The machine error correction program 108 may, in such cases, predict a temporal window for next failures and, if the temporal window between the moment and the predicted temporal window is greater than a minimum duration required to act, the machine error correction program 108 may request or advise a human user to physically install additional sensors, activate pre-existing sensors, or move portable sensor arrays to pre-determined positions around the industrial robot prior to the predicted temporal window so as to collect sensor data at the predicted time when the error condition would occur. In embodiments, the machine error correction program 108 may collect sensor data during the temporal window to determine whether any applied corrections/modifications have successfully resolved the error condition.

At 210, the machine error correction program 108 may present the proposed corrections to a subject matter expert. Here, the machine error correction program 108 may interact with the subject matter expert participating in a mixed-reality environment via a digital avatar in a mixed-reality environment to communicate the proposed corrections. The machine error correction program 108 may use natural language techniques, generative AI, et cetera to formulate natural language prompts in real time to interact with the subject matter expert, answer questions, and provide information regarding the proposed corrections in real time. For example, the AI avatar may communicate audibly using natural language speech, visually using text boxes or text overlaid onto the mixed-reality environment or transmitted to another participant's graphical user interface or mobile device, and/or may communicate using graphical elements such as graphs or tables or illustrations or infographics overlaid onto the mixed reality environment. The subject matter expert may be a human, but in embodiments, the subject matter expert may be a software agent comprising, for example, a machine learning model or smart program that receives data from all AI avatars comprising an organization, and which may have access to more data, more human oversight, and/or may be otherwise better empowered to authorize corrections that the AI avatar.

In embodiments of the invention, for example where multiple industrial robots are experiencing an error condition at the same time, or where AI avatars remain active in the mixed-reality environment even where they are not associated with industrial robots experiencing an error condition, multiple AI avatars may converse with each other in a planned or ad hoc basis, for example when an error condition appears to be caused by and/or affect multiple industrial robots at once, and/or where events occur that impact the industrial operations of the production line or if machine error correction program 108 conducts digital twin simulation scenarios that predict changes to operational efficiency, cycle time or tasks having defective outputs. The AI avatars may have access to different information, such as the corpus of information pertaining to the particular industrial robot or class of industrial robots associated with a particular AI avatar and may need to connect to share such information. The AI avatars may converse with each other utilizing natural language between digital avatars in the mixed reality environment, such that human users and/or subject matter experts participating in the mixed-reality experience may listen to and interact with the conversation between the AI avatars.

In embodiments, for example where the machine error correction program 108 has not identified any proposed corrections, the machine error correction program 108 may present the collated data to a subject matter expert. Here, the machine error correction program 108 may interact with the subject matter expert participating in a mixed-reality environment via a digital avatar in a mixed-reality environment to communicate the collated data. The machine error correction program 108 may use natural language techniques, generative AI, et cetera to formulate natural language prompts in real time to interact with the subject matter expert, answer questions, and provide information regarding the collated data in real time. In embodiments, for example where the machine error correction program 108 has failed to successfully identify any proposed corrections, the machine error correction program 108 may prompt the subject matter expert to provide one or more corrections based on the collated data to implement as authorized corrections.

In embodiments, for example where the machine error correction program 108 has identified multiple proposed corrections, the machine error correction program 108 may prompt the subject matter expert to choose one or more corrections to implement as authorized corrections. In some embodiments, the machine error correction program 108 may receive one or more authorized corrections from the subject matter expert, which may be selected from the one or more proposed corrections. Here, responsive to the machine error correction program 108 presenting the collated data and/or the proposed corrections, the subject matter expert may provide one or more authorized corrections, which may be one or more corrections authorized by the subject matter expert for implementation by the machine error correction program 108. In embodiments of the invention, the machine error correction program 108 may simulate the authorized correction using by any available modelling technique, such as a digital twin of the production line or system modelling. If the authorized corrections resolve the error condition when implemented in the simulation, the machine error correction program 108 may proceed to implement the authorized corrections. If the authorized corrections do not resolve the error condition when implemented in the simulation, the machine error correction program 108 may contact the subject matter expert.

At 212, the machine error correction program 108 may modify one or more algorithms of the industrial robot based on the one or more proposed corrections. The AI avatar, alone or in conjunction with other AI avatars, may determine the cause and corrections to be made, and machine error correction program 108 may be able to generate the program corrections or the determined functional parameters' changes, for example, from the mixed-reality discussions with other AI avatars or the subject matter experts. The corrections or extensions of the boundaries or corrections of the blind spots which lead to the rejection of input materials may involve updating the operational routines that control the robot or modifying the functional parameters, such as modifying the angle of the camera observing the material inflow belt. In other words, the authorized corrections may comprise adjustments to control algorithms to calculate and generate control commands that instruct the robot on how to operate in a revised fashion that corrects the error state. These commands may involve adjustments to the robot's joint angles, speeds, manipulator position, or toolpath. The machine error correction program 108 may interact with the control algorithms/software of the industrial robots to insert commands or alter values within the code to correct the error state.

In embodiments, for example where the machine error correction program 108 receives one or more authorized corrections from a subject matter expert, the machine error correction program 108 may modify one or more algorithms of the industrial robot based on the one or more authorized corrections.

At 214, the machine error correction program 108 may test the proposed corrections made to the modified one or more algorithms. Here, the machine error correction program 108 may record sensor data to identify whether the error has reoccurred. Here the sensors of the industrial robot may identify a similar situation to the error condition, and/or the number of input material rejects may have decreased, with the cause having been the issue that has been fixed by the corrections. In embodiments where the machine error correction program 108 has predicted a temporal window when the error is likely to reoccur, the machine error correction program 108 may record sensor data during the temporal window. If the error does not reoccur when expected, the correction has successfully corrected the error condition. The results of the test, for example whether the error condition has reoccurred, may be recorded for presentation to a subject matter expert.

In embodiments, for example where the machine error correction program 108 modified the one or more algorithms with one or more authorized corrections received from a human user, the machine error correction program 108 may test the authorized corrections made to the modified one or more algorithms.

At 216, the machine error correction program 108 may present an analysis of the test to the subject matter expert. Here, the machine error correction program 108 may interact with the subject matter expert participating in a mixed-reality environment via the AI avatar in a mixed-reality environment to communicate the results of the test. The machine error correction program 108 may use natural language techniques, generative AI, et cetera to formulate natural language prompts in real time to interact with the subject matter expert, answer questions, and provide information regarding the results of the test in real time. In embodiments, the AI avatar may present the analysis of the test to one or more other AI avatars or other software agents using natural language, such that other participants in the mixed reality environment might benefit from the exchange.

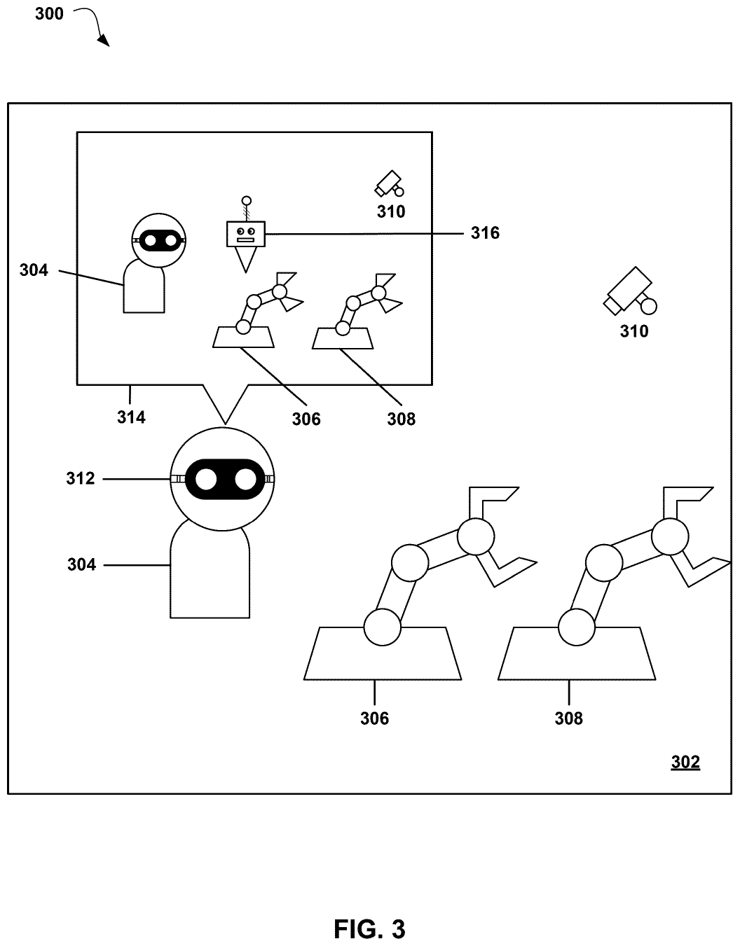

With respect to FIG. 3, a diagram illustrating an exemplary implementation 300 of a machine error correction process 200 is depicted according to at least one embodiment. Here, a user 304, an industrial robot 306 experiencing an error condition, and an industrial robot 308 which is not experiencing an error condition, and a sensor 310 are located within a geographical real-world region comprising production line 302. The user 304 is wearing a mixed-reality headset 312, through which the user is accessing a mixed reality environment 314 hosted by industrial mixed-reality platform 107. Here, the mixed-reality environment 314 comprises an augmented reality environment that encompasses the real-world environment of production line 302. As such, the mixed-reality environment 314 comprises the already-present physical objects and individuals within production line 302, including user 304, the industrial robot 306 which is experiencing an error condition, the industrial robot 308 which is not experiencing an error condition, and sensor 310. The mixed-reality environment 314 additionally comprises a number of virtual elements, including AI avatar 316, which is associated with and represents the industrial robot 306 experiencing an error condition. As the AI avatar 316 is virtual, it is visible within mixed-reality environment 314 but is not present in the production line 302. Because industrial robot 308 is not experiencing an error condition, there is no AI avatar 316 associated with industrial robot 308. In embodiments of the invention, all industrial robots within a production line may be represented by AI avatars 316 within a mixed-reality environment 314 whether or not they are experiencing an error condition.

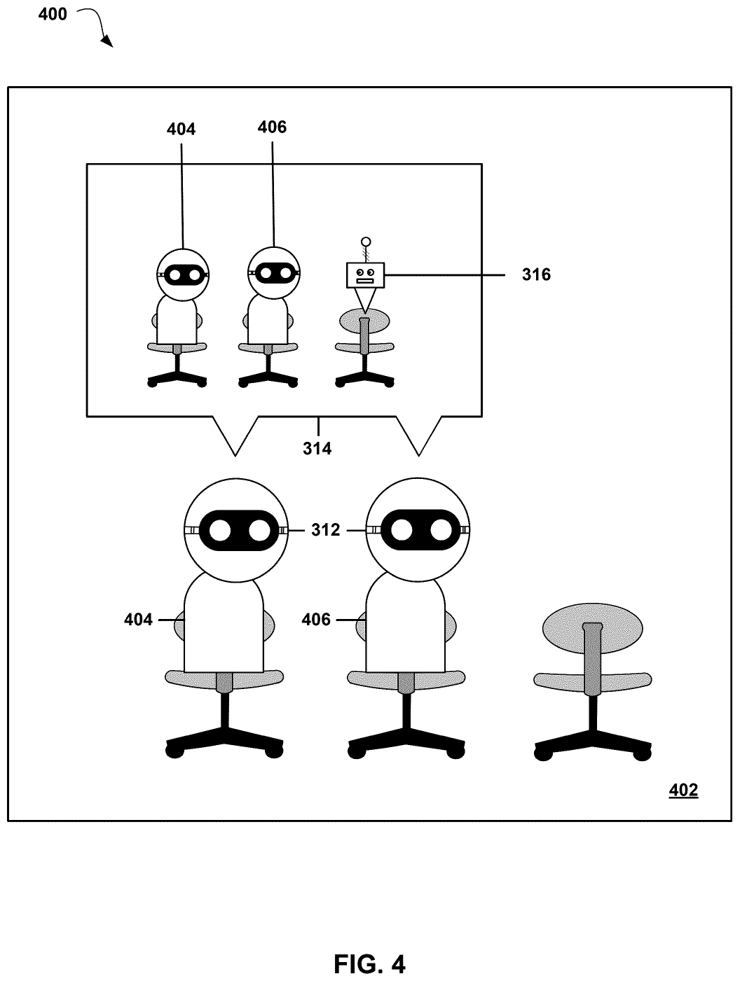

With respect to FIG. 4, a diagram illustrating an exemplary implementation 400 of a machine error correction process 200 is depicted according to at least one embodiment. Here, a geographical region comprising an office 402 is depicted which comprises a first user 404 and a second user 406. The first user 404 and the second user 406 are wearing mixed-reality devices 312, through which they are participating within a mixed reality environment 314. Here, the mixed-reality environment 314 is an augmented-reality environment encompassing the office 402, such that the first user 404 and the second user 406 occupy their same relative and absolute locations within both the office 402 and the mixed-reality environment 314. The mixed reality environment 314 further comprises the AI avatar 316, which is representing the industrial robot 306 which is experiencing an error condition; while the industrial robot 306 is not present in the office 402, the AI avatar 316 is not restricted to the location of the industrial robot 306, and may be located anywhere in mixed-reality environment 314 and/or may move about or change location within the mixed-reality environment 314. As the AI avatar 316 is virtual, it is visible within mixed-reality environment 314 but is not present in the office 402. In embodiments, the AI avatar 316 may simultaneously be present in multiple mixed-reality environments 314, such as a production line 302 and an office 402; furthermore, multiple AI avatars 316 representing a single industrial robot 306 may be present in a single mixed-reality environment 314. In embodiments, the mixed-reality environment 314 may be a virtual reality environment, and the first user 404 may be located many feet or miles distant from second user 406 but may still be sitting next to second user 406 within the mixed-reality environment 314.

It may be appreciated that FIGS. 2-4 provide only illustrations of individual implementations and do not imply any limitations with regard to how different embodiments may be implemented. Many modifications to the depicted environments may be made based on design and implementation requirements. For example, one skilled in the art would appreciate that embodiments of the invention may involve AI avatars resolving error conditions autonomously, with no human input. In such embodiments, the AI avatars may interact with each other or other software subject matter experts within the mixed reality environment.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for industrial robot error correction, the method comprising:
monitoring a production line for error conditions;
responsive to identifying an error condition in an industrial robot comprising the production line, invoking an AI avatar for the industrial robot;
gathering, by the AI avatar, data pertaining to the error condition;
analyzing, by the AI avatar, the gathered data to produce a plurality of collated data and/or one or more proposed corrections;
presenting, by the AI avatar, the plurality of collated data and/or the one or more proposed corrections in a mixed reality environment; and
modifying one or more algorithms of the industrial robot based on the one or more proposed corrections.

2. The method of claim 1, further comprising:
testing the one or more proposed corrections made to the modified one or more algorithms.

3. The method of claim 2, further comprising:
presenting, by the AI avatar, an analysis of the testing within the mixed reality environment.

4. The method of claim 2, wherein the analyzing comprises predicting one or more future error conditions occurring within a predicted window; and wherein the testing occurs during the predicted window.

5. The method of claim 1, wherein the analyzing comprises:
predicting one or more future error conditions occurring within a predicted window; and wherein the method further comprises:
adding or enabling one or more sensors to the production line based on the prediction.

6. The method of claim 1, wherein the AI avatar comprises an interactable digital representation of the industrial robot integrated into a mixed-reality platform.

7. The method of claim 1, wherein data pertaining to the error condition comprises data recorded from one or more sensors outside of a boundary of the industrial robot.

8. A computer system for industrial robot error correction, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
monitoring a production line for error conditions;
responsive to identifying an error condition in an industrial robot comprising the production line, invoking an AI avatar for the industrial robot;
gathering, by the AI avatar, data pertaining to the error condition;
analyzing, by the AI avatar, the gathered data to produce a plurality of collated data and/or one or more proposed corrections;
presenting, by the AI avatar, the plurality of collated data and/or the one or more proposed corrections in a mixed-reality environment; and
modifying one or more algorithms of the industrial robot based on the one or more proposed corrections.

9. The computer system of claim 8, further comprising:
testing the one or more proposed corrections made to the modified one or more algorithms.

10. The computer system of claim 9, further comprising:
presenting, by the AI avatar, an analysis of the testing in the mixed-reality environment.

11. The computer system of claim 9, wherein the analyzing comprises predicting one or more future error conditions occurring within a predicted window; and wherein the testing occurs during the predicted window.

12. The computer system of claim 8, wherein the analyzing comprises:
predicting one or more future error conditions occurring within a predicted window; and wherein the method further comprises:
adding or enabling one or more sensors to the production line based on the prediction.

13. The computer system of claim 8, wherein the AI avatar comprises an interactable digital representation of the industrial robot integrated into a mixed-reality platform.

14. The computer system of claim 8, wherein data pertaining to the error condition comprises data recorded from one or more sensors outside of a boundary of the industrial robot.

15. A computer program product for industrial robot error correction, the computer program product comprising:
one or more computer-readable tangible storage medium and program instructions stored on at least one of the one or more tangible storage medium, the program instructions executable by a processor to cause the processor to perform a method comprising:
monitoring a production line for error conditions;
responsive to identifying an error condition in an industrial robot comprising the production line, invoking an AI avatar for the industrial robot;
gathering, by the AI avatar, data pertaining to the error condition;
analyzing, by the AI avatar, the gathered data to produce a plurality of collated data and/or one or more proposed corrections;
presenting, by the AI avatar, the plurality of collated data and/or the one or more proposed corrections to a subject matter expert; and
modifying one or more algorithms of the industrial robot based on the one or more proposed corrections.

16. The computer program product of claim 15, further comprising:
testing the one or more proposed corrections made to the modified one or more algorithms.

17. The computer program product of claim 16, further comprising:
presenting, by the AI avatar, an analysis of the testing to the subject matter expert.

18. The computer program product of claim 16, wherein the analyzing comprises predicting one or more future error conditions occurring within a predicted window; and wherein the testing occurs during the predicted window.

19. The computer program product of claim 15, wherein the analyzing comprises:
predicting one or more future error conditions occurring within a predicted window; and wherein the method further comprises:
adding or enabling one or more sensors to the production line based on the prediction.

20. The computer program product of claim 15, wherein the AI avatar comprises an interactable digital representation of the industrial robot integrated into a mixed-reality platform.
